(19) United States
(12) Patent Application Publication
(10) Pub. No.: US 2026/0347099 A1
(43) Pub. Date: Nov. 5, 2026

(54) REFUSE BODY PACKOUT DETECTION

(71) Applicant: Oshkosh Corporation, Oshkosh, WI (US)

(72) Inventors: Quincy Wittman, Oshkosh, WI (US); Derek Wente, Austin, MN (US); Ross Turner, Oshkosh, WI (US); Jacob Wallin, Oshkosh, WI (US); Nicholas Weykamp, Oshkosh, WI (US); Jeff Meyer, Oshkosh, WI (US); Jacob Gervais, Oshkosh, WI (US); Shawn Sanchez, Oshkosh, WI (US); Vince Schad, Oshkosh, WI (US)

(73) Assignee: Oshkosh Corporation, Oshkosh, WI (US)

(21) Appl. No.: 19/664,685

(22) Filed: Apr. 30, 2026

Related U.S. Application Data
(60) Provisional application No. 63/799,268, filed on May 2, 2025.

(51) Int. Cl. B65F 3/20; B65F 3/14

(52) U.S. Cl. CPC B65F 3/201; B65F 2003/146

(57) ABSTRACT

A refuse vehicle is provided. The refuse vehicle may include a chassis, a cab coupled to the chassis, a refuse compartment coupled to the chassis, a packing assembly, a pack sensor, and a controller. The refuse compartment defines a storage volume. The packing assembly is disposed within the refuse compartment. The packing assembly includes a pack panel and a packing actuator. The packing actuator is configured to selectively move the pack panel between a retracted position and an extended position. The controller is communicably coupled to the pack sensor. The controller is configured to receive sensor data from the pack sensor. The controller is further configured to determine, based on the sensor data, whether a volume of refuse stored within the storage volume satisfies a threshold volume. The controller is further configured to initiate a remedial action in response to determining that the volume of refuse satisfies the threshold volume.

### CROSS-REFERENCE TO RELATED APPLICATIONS

The present application claims the benefit of and priority to U.S. Provisional Patent Application No. 63/799,268, filed on May 2, 2025, the entire contents of which are hereby incorporated by reference herein.

### BACKGROUND

The present disclosure relates generally to the field of refuse vehicles.

### SUMMARY

An exemplary embodiment of the present disclosure relates to a refuse vehicle. The refuse vehicle may include a chassis, a cab, a refuse compartment, a packing assembly, a pack sensor, and a controller. The cab is coupled to the chassis. The refuse compartment is coupled to the chassis and defines a storage volume. The packing assembly is disposed within the refuse compartment. The packing assembly includes a pack panel and a packing actuator. The packing actuator is configured to selectively move the pack panel between a retracted position and an extended position. The controller is communicably coupled to the pack sensor. The controller is configured to receive sensor data from the pack sensor. The controller is further configured to determine, based on the sensor data, whether a volume of refuse stored within the storage volume satisfies a threshold volume. The controller is further configured to initiate a remedial action in response to determining that the volume of refuse satisfies the threshold volume.

Another exemplary embodiment of the present disclosure relates to a body for storing and compacting refuse. The body may include a refuse compartment, a packing assembly, a pack sensor, and a controller. The refuse compartment defines a storage volume. The packing assembly is disposed within the refuse compartment. The packing assembly includes a pack panel and a packing actuator. The packing actuator is configured to selectively move the pack panel between a retracted position and an extended position. The controller is communicably coupled to the pack sensor. The controller is configured to receive sensor data from the pack sensor. The controller is further configured to determine, based on the sensor data, a volume of refuse stored within the storage volume.

Another exemplary embodiment of the present disclosure relates to a method of measuring a volume of refuse within a refuse compartment of a refuse vehicle. The method may include receiving sensor data from a pack sensor. The method may further include determining, based on the sensor data, whether a volume of refuse stored within the refuse compartment satisfies a threshold volume. The method may further include initiating a remedial action in response to determining that the volume of refuse satisfies the threshold volume.

Another exemplary embodiment of the present disclosure relates to a refuse vehicle. The refuse vehicle includes a chassis, a cab coupled to the chassis, a refuse compartment coupled to the chassis, a packing assembly disposed within the refuse compartment, and a pack sensor. The refuse compartment defines a storage volume. The packing assembly includes a pack panel and a packing actuator. The packing actuator is configured to selectively move the pack panel between a retracted position and an extended position. The pack sensor is configured to output data indicative of a volume of refuse stored within the storage volume.

In some embodiments, the pack sensor is a rotary encoder coupled to the packing actuator. In some embodiments, the pack sensor is a linear encoder coupled to the packing actuator. In some embodiments, the pack sensor is a distance sensor configured to output data indicative of a distance of the pack panel from the retracted position. In some embodiments, the pack sensor is a strain gauge fixed to the refuse compartment. In some embodiments, the refuse vehicle further includes a tailgate rotatably coupled to the refuse compartment and movable between an opened position and a closed position, and a locking assembly configured to selectively secure the tailgate in the closed position. In some such embodiments, the pack sensor is a strain gauge fixed to a component of the locking mechanism. In some embodiments, the packing actuator is a hydraulic actuator, and the pack sensor is a pressure sensor configured to measure a pressure of the packing actuator. In some embodiments, the packing actuator is a hydraulic actuator, and the pack sensor is a flow meter configured to measure a flow of hydraulic fluid into the packing actuator.

Another exemplary embodiment of the present disclosure relates to a method of measuring a volume of refuse within a refuse compartment of a refuse vehicle. The method includes receiving refuse into the refuse compartment of the refuse vehicle. The method also includes compacting the refuse in the refuse compartment of the refuse vehicle. The method also includes receiving data from a pack sensor configured to generate output data indicative of the volume of refuse within the refuse compartment of the refuse vehicle. The method also includes determining from the output data whether the volume of refuse within the refuse compartment of the refuse vehicle is at or near a capacity of the refuse compartment. Finally, the method includes initiating remedial action.

Another exemplary embodiment of the present disclosure relates to a body for storing and compacting refuse. The body includes a packing assembly disposed within the body and a pack sensor. The packing assembly includes a pack panel and a packing actuator. The packing actuator is configured to selectively move the pack panel between a retracted position and an extended position. The pack sensor is configured to output data indicative of a volume of refuse stored within the body.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a side view of a rear-loading refuse vehicle, according to an exemplary embodiment;

FIG. 3 is a perspective view of a side-loading refuse vehicle, according to an exemplary embodiment;

FIG. 4 is a perspective view of a refuse compartment and hopper volume of a refuse vehicle, according to an exemplary embodiment;

FIG. 5 is a perspective view of the refuse compartment and the hopper volume of FIG. 4 with a pack panel at least partially extended, according to an exemplary embodiment;

FIG. 6 is a cross-sectional view of a refuse compartment and a packing assembly of a refuse vehicle, with a pack panel in a retracted position, according to an exemplary embodiment;

FIG. 7 is a cross-sectional view of a refuse compartment and a packing assembly of a refuse vehicle, with a pack panel extended between a retracted position and an extended position, according to an exemplary embodiment;

FIG. 8 is a cross-sectional view of a refuse compartment and a packing assembly of a refuse vehicle, with a pack panel in an extended position, according to an exemplary embodiment;

FIG. 9 is a schematic illustration of a refuse vehicle with a pack panel in a first position between a retracted position and an extended position, according to an exemplary embodiment;

FIG. 10 is a schematic illustration of a refuse vehicle with a pack panel in a second position between a retracted position and an extended position, according to an exemplary embodiment;

FIG. 11 is a schematic illustration of a refuse vehicle with a pack panel in a third position between a retracted position and an extended position, according to an exemplary embodiment;

FIG. 12A is a perspective view of a refuse compartment and a packing assembly of a refuse vehicle, according to an exemplary embodiment;

FIG. 12B is a cross-sectional perspective view of the refuse compartment and packing assembly of FIG. 12A, according to an exemplary embodiment;

FIGS. 13A-13C are schematic illustrations of a refuse compartment and a packing assembly, a linear encoder is coupled to a part of the packing assembly, according to an exemplary embodiment;

FIGS. 14A-14C are schematic illustrations of a refuse compartment and a packing assembly, a rotary encoder is coupled to a part of the packing assembly, according to an exemplary embodiment;

FIGS. 15A-15C are schematic illustrations of a refuse compartment and a packing assembly, a range sensor is positioned behind a part of the packing assembly, according to an exemplary embodiment;

FIGS. 16A and 16B are side views of a refuse compartment including a locking mechanism, the locking mechanism is shown in an unlocked position in FIG. 16A and the locking mechanism is shown in a locked position in FIG. 16B, according to an exemplary embodiment;

FIGS. 17A and 17B are side views of a refuse compartment including a locking mechanism, the locking mechanism is shown in an unlocked position in FIG. 17A and the locking mechanism is shown in a locked position in FIG. 17B, according to an exemplary embodiment;

FIG. 18A is a side view of a refuse compartment including a locking mechanism, according to an exemplary embodiment;

FIG. 18B is an enlarged side view of the refuse compartment and locking mechanism of FIG. 18A, according to an exemplary embodiment;

FIG. 19A is a side view of a refuse compartment, according to an exemplary embodiment;

FIG. 19B is a side view of the refuse compartment of FIG. 19A including a locking mechanism, according to an exemplary embodiment;

FIG. 20 is a perspective view of the locking mechanism of FIG. 19B, according to an exemplary embodiment;

FIGS. 21A and 21B are partial perspective views of the locking mechanism of FIG. 20 installed on a refuse vehicle, according to an exemplary embodiment;

FIGS. 22A and 22B are side views of locking plates of the locking mechanism of FIG. 20, according to exemplary embodiments;

FIG. 23A is a perspective view of another refuse vehicle, according to an exemplary embodiment;

FIG. 23B is a perspective view of the body of the refuse vehicle of FIG. 23A, according to an exemplary embodiment;

FIGS. 24A-24D are schematic illustrations of strain gauge circuits, according to various exemplary embodiments;

FIG. 25 is a schematic illustration of a fluid control circuit configured to extend and/or retract a hydraulic actuator, according to an exemplary embodiment;

FIG. 26 is a block diagram of a control system for a refuse vehicle, according to an exemplary embodiment; and

FIG. 27 is a flow diagram of a method of operating a refuse vehicle with a pack sensor, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overview

Refuse vehicles (e.g., a garbage truck, a waste collection truck, a sanitation truck, etc.) are vehicles configured to collect, process, and transport refuse. Refuse vehicles generally include a refuse compartment (i.e., a storage body) to store refuse collected by the refuse vehicle. The refuse compartment may include a packing assembly to facilitate both the compaction of refuse within the refuse compartment, and ultimately the ejection of refuse from the refuse compartment at a landfill or other deposit/transfer facility. It can be difficult for the operator of a refuse vehicle to know how much refuse has already been collected and is being stored in the refuse compartment of the refuse vehicle during a refuse collection route. Overfilling of the refuse compartment with refuse can cause damage to the refuse compartment or the packing assembly. At the very least, overfilling can create an inconvenience for the operator.

Referring generally to the Figures, refuse vehicles and systems configured to measure/determine a volume of refuse material within a refuse compartment are shown, according to various exemplary embodiments. The system includes a sensor configured to measure an operating characteristic of a component of the refuse vehicle during the compaction of refuse within the refuse vehicle's refuse compartment. In some embodiments, the sensor is configured to measure the position of a component of the packing assembly during the packing process. In other embodiments, the sensor is configured to measure strain on a part of the refuse vehicle during the packing process, and/or a pressure exerted by one or more components of the refuse vehicle on materials within the refuse compartment. In still other embodiments, the sensor is configured to measure the operating characteristics of a hydraulic circuit controlling a packing actuator during the packing process. In some embodiments, the system includes a controller to receive and interpret the data generated by the sensor and to initiate remedial action, such as warning the operator or disabling working components of the refuse vehicle based on the sensor data to prevent damage. Accordingly, the refuse vehicles described herein provide an improved means of collecting, processing, and transporting refuse.

### Refuse Vehicle

### Front-Loading Configuration

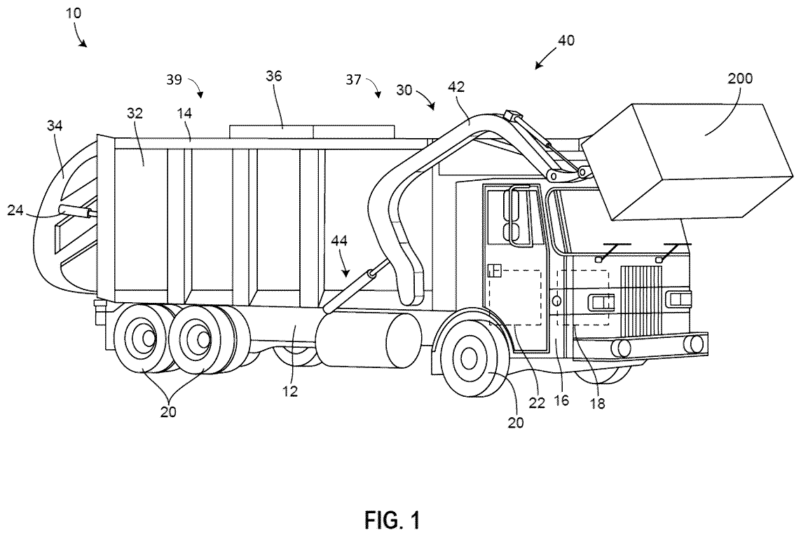

Referring to FIG. 1, a vehicle, shown as refuse vehicle 10 (e.g., a garbage truck, a waste collection truck, a sanitation truck, etc.), is shown that is configured to collect and store refuse along a collection route. In the embodiment of FIG. 1, the refuse vehicle 10 is configured as a front-loading refuse vehicle. The refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, hydraulic controls, a user interface, an acceleration pedal, a brake pedal, a clutch pedal, a gear selector, switches, buttons, dials, etc.). As shown in FIG. 1, the refuse vehicle 10 includes a prime mover, shown as engine 18, coupled to the frame 12 at a position beneath the cab 16. The engine 18 is configured to provide power to tractive elements, shown as wheels 20, and/or to other systems of the refuse vehicle 10 (e.g., a pneumatic system, a hydraulic system, etc.). The engine 18 may be configured to utilize one or more of a variety of fuels (e.g., gasoline, diesel, bio-diesel, ethanol, natural gas, etc.), according to various exemplary embodiments. The fuel may be stored in a tank 28 (e.g., a vessel, a container, a capsule, etc.) that is fluidly coupled with the engine 18 through one or more fuel lines.

According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 10. The engine 18 may transfer output torque to or drive the wheels 20 of the refuse vehicle 10 through a transmission 22. The engine 18, the transmission 22, and one or more shafts, axles, gearboxes, etc., may define a driveline of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume 37 and a storage volume 39. Refuse may be initially loaded into the hopper volume 37 and thereafter transferred and/or compacted into the storage volume 39. According to an exemplary embodiment, the hopper volume 37 is positioned forward of the cab 16 (e.g., refuse is loaded into a position of the refuse compartment 30 in front of the cab 16, a front-loading refuse vehicle, etc.). In other embodiments, the hopper volume 37 is positioned between the storage volume 39 and the cab 16 (e.g., refuse is loaded into a position of the refuse compartment 30 behind the cab 16 and stored in a position further toward the rear of the refuse compartment 30). In yet other embodiments, the storage volume 39 is positioned between the hopper volume 37 and the cab 16 (e.g., a rear-loading refuse vehicle, etc.).

The tailgate 34 may be hingedly or pivotally coupled with the body 14 at a rear end of the body 14 (e.g., opposite the cab 16). The tailgate 34 may be driven to rotate between an open position and a closed position by tailgate actuators 24. The refuse compartment 30 may be hingedly or pivotally coupled with the frame 12 such that the refuse compartment 30 can be driven to raise or lower while the tailgate 34 is open in order to dump contents of the refuse compartment 30 at a landfill. The refuse compartment 30 may include a packer assembly (e.g., a compaction apparatus) positioned therein that is configured to compact loose refuse.

Referring still to FIG. 1, the refuse vehicle 10 includes a first lift mechanism or system (e.g., a front-loading lift assembly, etc.), shown as lift assembly 40. The lift assembly 40 includes a pair of arms, shown as lift arms 42, coupled to at least one of the frame 12 or the body 14 on either side of the refuse vehicle 10 such that the lift arms 42 extend forward of the cab 16 (e.g., a front-loading refuse vehicle, etc.). The lift arms 42 may be rotatably coupled to frame 12 with a pivot (e.g., a lug, a shaft, etc.). The lift assembly 40 includes first actuators, shown as lift arm actuators 44 (e.g., hydraulic cylinders, etc.), coupled to the frame 12 and the lift arms 42. The lift arm actuators 44 are positioned such that extension and retraction thereof rotates the lift arms 42 about an axis extending through the pivot, according to an exemplary embodiment. Lift arms 42 may be removably coupled to a container, shown as refuse container 200 in FIG. 1. Lift arms 42 are configured to be driven to pivot by lift arm actuators 44 to lift and empty the refuse container 200 into the hopper volume 37 for compaction and storage. The lift arms 42 may be coupled with a pair of forks or elongated members that are configured to removably couple with the refuse container 200 so that the refuse container 200 can be lifted and emptied. The refuse container 200 may be similar to the container attachment as described in greater detail in U.S. application Ser. No. 17/558,183, filed Dec. 12, 2021, the entire disclosure of which is incorporated by reference herein.

### Rear-Loading Configuration

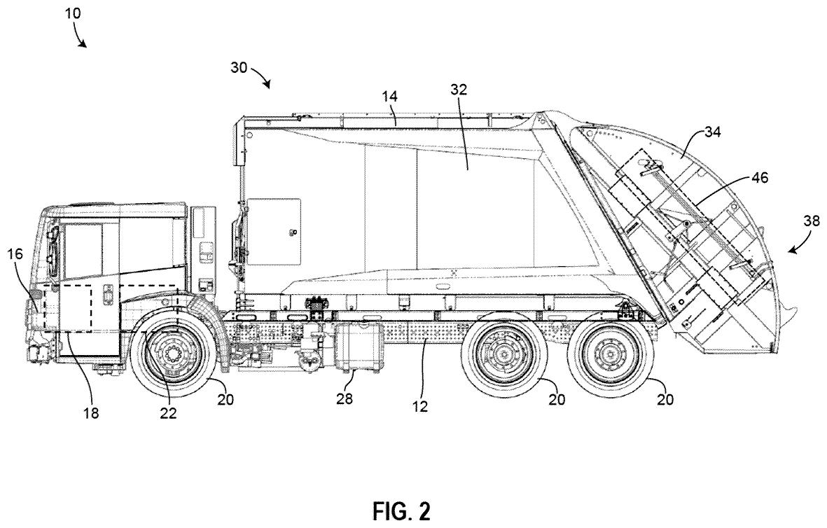

As shown in FIG. 2, the refuse vehicle 10 may be configured as a rear-loading refuse vehicle, according to some embodiments. In the rear-loading embodiment of the refuse vehicle 10, the tailgate 34 defines an opening 38 through which loose refuse may be loaded into the refuse compartment 30. The tailgate 34 may also include a packer 46 (e.g., a packing assembly, a compaction apparatus, a claw, a hinged member, etc.) that is configured to draw refuse into the refuse compartment 30 for storage. Similar to the embodiment of the refuse vehicle 10 described in FIG. 1 above, the tailgate 34 may be hingedly coupled with the refuse compartment 30 such that the tailgate 34 can be opened or closed during a dumping operation.

### Side-Loading Configuration

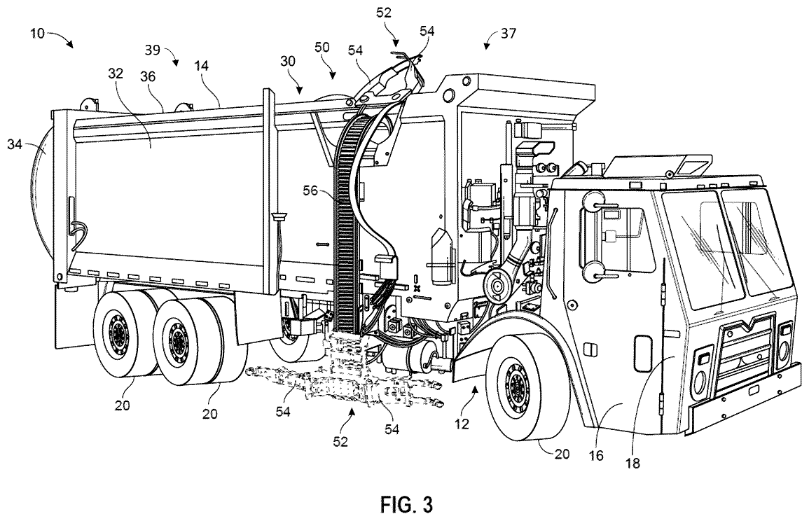

Referring to FIG. 3, the refuse vehicle 10 may be configured as a side-loading refuse vehicle (e.g., a zero radius side-loading refuse vehicle). The refuse vehicle 10 includes a lift mechanism or system, shown as lift assembly 50. Lift assembly 50 includes a grabber assembly, shown as grabber assembly 52, movably coupled to a track, shown as track 56, and configured to move along an entire length of track 56. According to the exemplary embodiment shown in FIG. 3, track 56 extends along substantially an entire height of body 14 and is configured to cause grabber assembly 52 to tilt near an upper height of body 14. In other embodiments, the track 56 extends along substantially an entire height of body 14 on a rear side of body 14. The refuse vehicle 10 can also include a reach system or assembly coupled with a body or frame of refuse vehicle 10 and lift assembly 50. The reach system can include telescoping members, a scissors stack, etc., or any other configuration that can extend or retract to provide additional reach of grabber assembly 52 for refuse collection.

Referring still to FIG. 3, grabber assembly 52 includes a pair of grabber arms shown as grabber arms 54. The grabber arms 54 are configured to rotate about an axis extending through a bushing. The grabber arms 54 are configured to releasably secure a refuse container to grabber assembly 52, according to an exemplary embodiment. The grabber arms 54 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 54 are rotated towards each other such that the refuse container is grasped therebetween. In the disengaged state, the grabber arms 54 rotate outwards such that the refuse container is not grasped therebetween. By transitioning between the engaged state and the disengaged state, the grabber assembly 52 releasably couples the refuse container with grabber assembly 52. The refuse vehicle 10 may pull up along-side the refuse container, such that the refuse container is positioned to be grasped by the grabber assembly 52 therebetween. The grabber assembly 52 may then transition into an engaged state to grasp the refuse container. After the refuse container has been securely grasped, the grabber assembly 52 may be transported along track 56 with the refuse container. When the grabber assembly 52 reaches the end of track 56, the grabber assembly 52 may tilt and empty the contents of the refuse container in refuse compartment 30. The tilting is facilitated by the path of the track 56. When the contents of the refuse container have been emptied into refuse compartment 30, the grabber assembly 52 may descend along the track 56 and return the refuse container to the ground. Once the refuse container has been placed on the ground, the grabber assembly may transition into the disengaged state, releasing the refuse container.

### Refuse Compartment

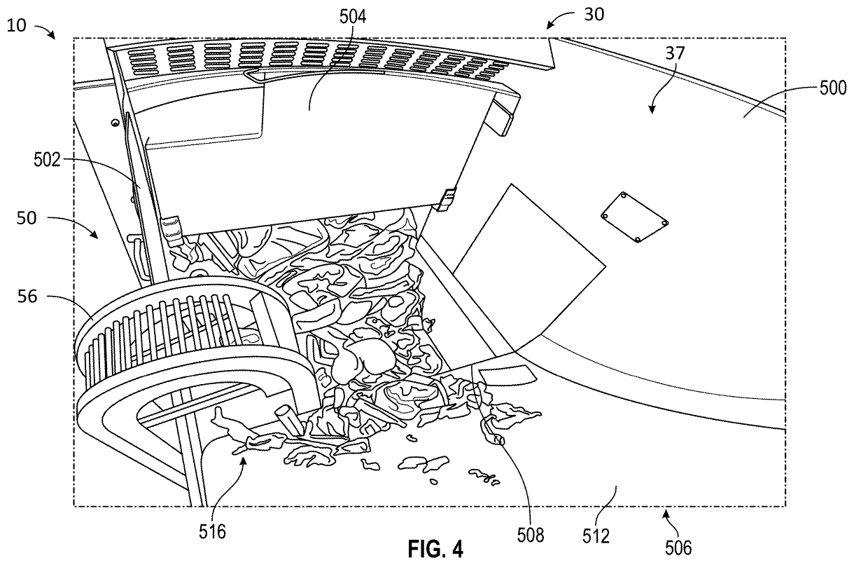

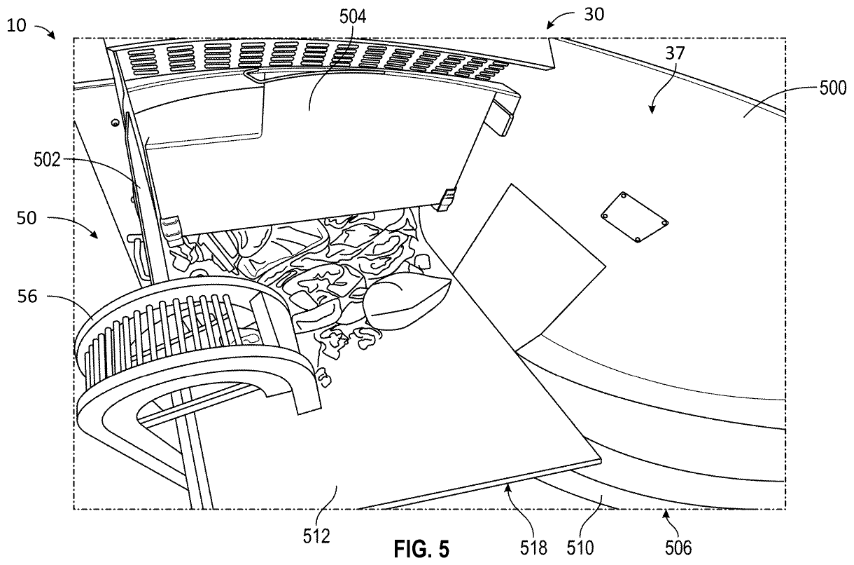

FIGS. 4 and 5 show an exemplary embodiment of the refuse compartment 30 of the refuse vehicle 10, shown here as a side-loading refuse vehicle. As shown in FIGS. 4 and 5, the hopper volume 37 is an internal volume of the refuse compartment 30 and is defined by a left sidewall 500, a right sidewall 502, a holding plate 504, and a packing assembly 506. The left sidewall 500 extends longitudinally (e.g., in a direction extending between the cab 16 and the tailgate 34) between the holding plate 504 and the packing assembly 506. The lift assembly 50 is arranged on the right sidewall 502, and the holding plate 504 extends downwardly (e.g., in a direction toward the frame 12, or in a direction perpendicular to the ground on which the refuse vehicle 10 travels) from a top wall of the refuse compartment 30. In general, the holding plate 504 separates the hopper volume 37 and the storage volume 39 and forms a partition between the two sections in the refuse compartment 30. In addition, the holding plate 504 aids in preventing refuse being packed into the storage volume 39 from falling back toward the hopper volume 37.

With reference to FIGS. 4-8, the packing assembly 506 includes a pack panel 508, a ramped or curved wall 510, a pivot plate 512, and a packing actuator 514. The pack panel 508 extends generally vertically (e.g., in a direction perpendicular to a road on which the refuse vehicle 10 travels) and faces in a direction toward the storage volume 39 (e.g., a normal extending from the outer surface of the pack panel 508 is directed toward the storage volume 39). A first end 516 of the pivot plate 512 is rotatably coupled to a distal end of the pack panel 508 so that the pivot plate 512 rotates relative to the pack panel 508 as the pack panel 508 moves between retracted and extended positions. A second end 518 of the pivot plate 512 is configured to engage and slide along the curved wall 510 (e.g., when the pack panel 508 is in a position where the second end 518 of the pivot plate 512 overlaps with the curved wall 510). The curved wall 510 defines a generally curved profile that ramps downwardly in a direction toward the storage volume 39.

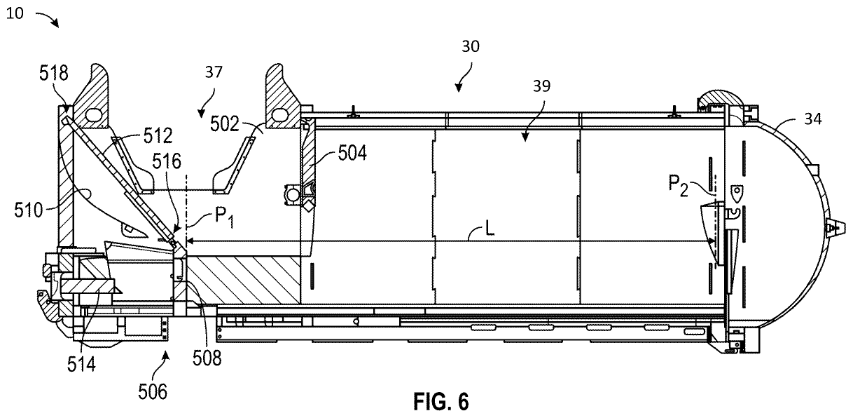

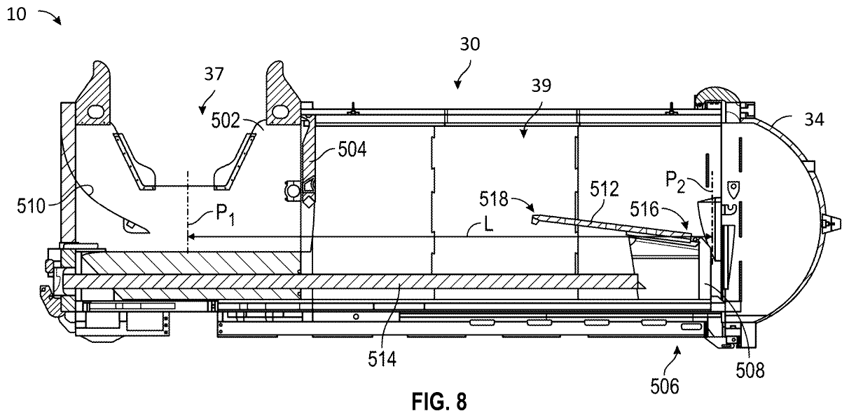

The pack panel 508 is coupled to the packing actuator 514 so that the packing actuator 514 selectively moves the pack panel 508 between a retracted or home position (see, e.g., FIGS. 4 and 6) and an extended or eject position (see, e.g., FIG. 8), between the extended position and the retracted position, and any position in between the extended position and the retracted position. In some embodiments, the packing actuator 514 is a telescoping actuator that is pneumatically, hydraulically, electronically, or electro-hydraulically driven.

### Packing and Ejection Procedures

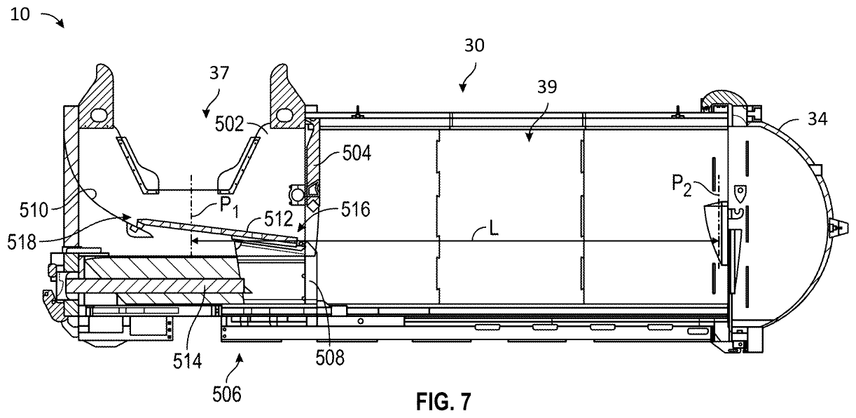

A packing procedure generally includes moving the pack panel 508 from the retracted position (see, e.g., FIGS. 4 and 6) to a position where the pack panel 508 is at least partially extended from the retracted position in a direction toward the extended position (see, e.g., FIGS. 5 and 7). In the retracted position, the pack panel 508 is arranged at least partially within the hopper volume 37, and the packing procedure extends the pack panel 508 toward the storage volume 39 to compact and displace refuse in the hopper volume 37 in a direction toward the storage volume 39. This enables the hopper volume 37 to be repeatedly filled and packed until the storage volume 39 is full and an ejection procedure is required.

The ejection procedure generally includes moving the pack panel 508, via the packing actuator 514, to the extended or eject position (see, e.g., FIG. 8). During the ejection procedure, the tailgate 34 is opened and the pack panel 508 is moved to the extended position and refuse in the storage volume 39 is ejected. The movement of the pack panel 508 between the retracted position and the extended position defines a travel length or distance of the pack panel 508. For example, in the retracted position, the pack panel 508 defines an initial plane P₁ and, in the extended position, the pack panel 508 defines a final plane P₂. A length L is defined between the initial plane P₁ and the final plane P₂ and represents the travel distance traversed by the pack panel 508 between the retracted and extended positions.

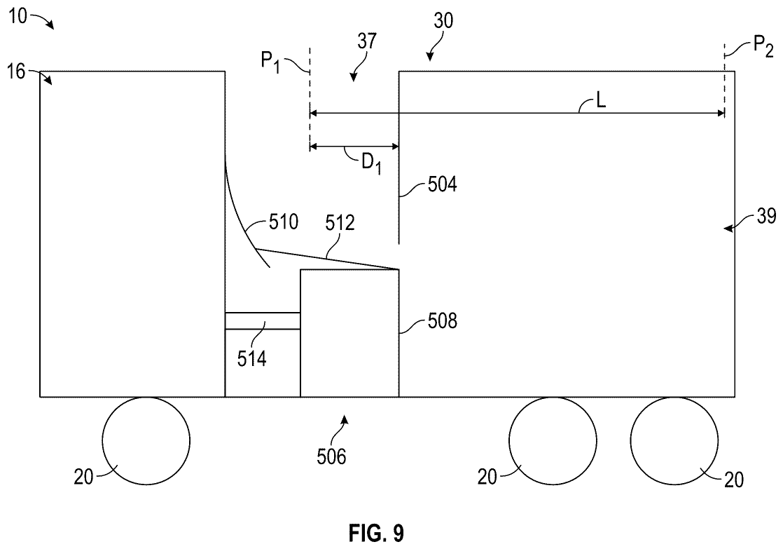

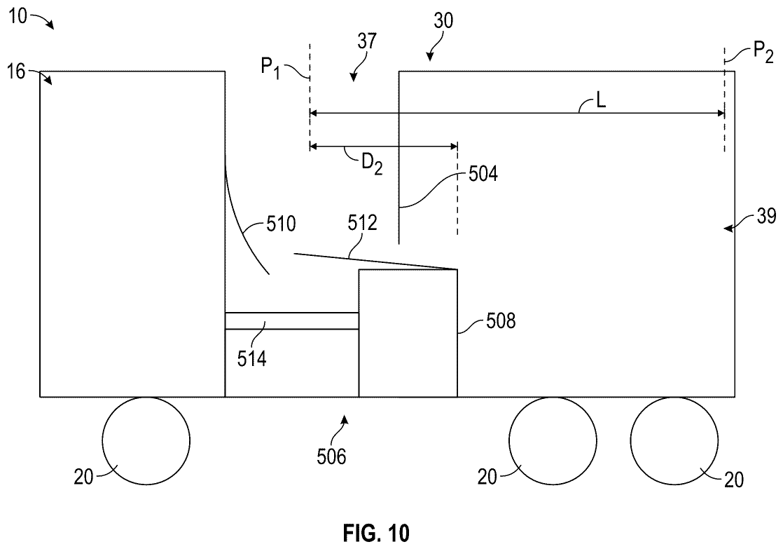

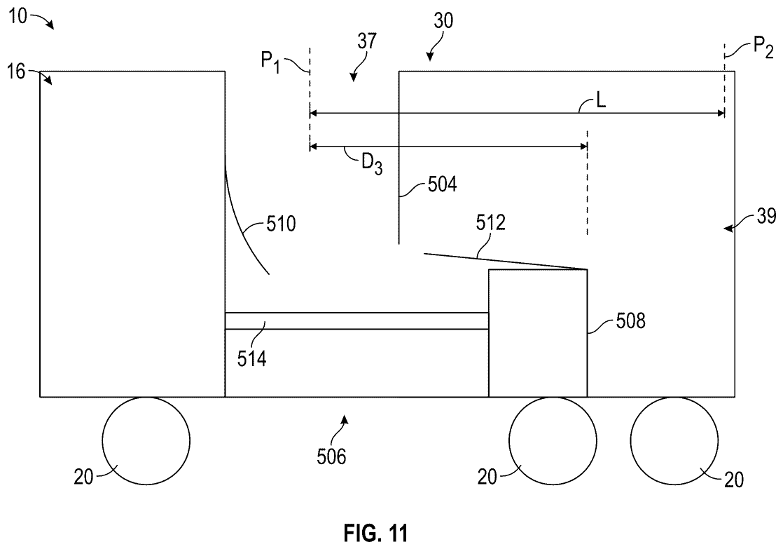

As described herein, the packing procedure generally includes moving the pack panel 508 from the retracted position to a position where the pack panel 508 is at least partially extended from the retracted position in a direction toward the extended position. The packing actuator 514 is configured to move the pack panel 508 to any position along the length L between the retracted position and the extended position. For example, turning to FIGS. 9-11, the packing actuator 514 is configured to move the pack panel 508 to a first position (FIG. 9), a second position (FIG. 10), or a third position (FIG. 11) along the length L. The second position is between the first position and the third position, and the first position is closer to the retracted position than the third position. In the first position, the pack panel 508 moves a first distance D₁ from the retracted position. The first distance D₁ is defined between the initial plane P₁ and the position of the pack panel 508 in the first position. In the second position, the pack panel 508 moves a second distance D₂ from the retracted position. The second distance D₂ is defined between the initial plane P₁ and the position of the pack panel 508 in the second position. In the third position, the pack panel 508 moves a third distance D₃ from the retracted position. The third distance D₃ is defined between the initial plane P₁ and the position of the pack panel 508 in the third position. The first distance D₁ is less than the second distance D₂, and the second distance D₂ is less than the third distance D₃. In some embodiments, the first distance D₁ is between about 0% and about 35% of the length L, the second distance D₂ is between about 35% and 65% of the length L, and the third distance D₃ is between about 65% and about 100% of the length L.

During the packing procedure, the packing actuator 514 can extend the pack panel 508 to any one of the first position, the second position, the third position, or any other position between the retracted position and the extended position. In some embodiments, the packing actuator 514 extends the pack panel 508 to generally align with the holding plate 504 during the packing procedure (see, e.g., FIGS. 7 and 9). For example, a distance between the pack panel 508 and the initial plane P1 can be within about 2%, 5%, or 10% of a distance between the initial plane P₁ and the holding plate 504 (e.g., a rear surface of the holding plate 504 that faces the storage volume 39). After the pack panel 508 extends away from the retracted position, the pack panel 508 returns to the retracted position to complete the packing procedure.

### Pack Sensor

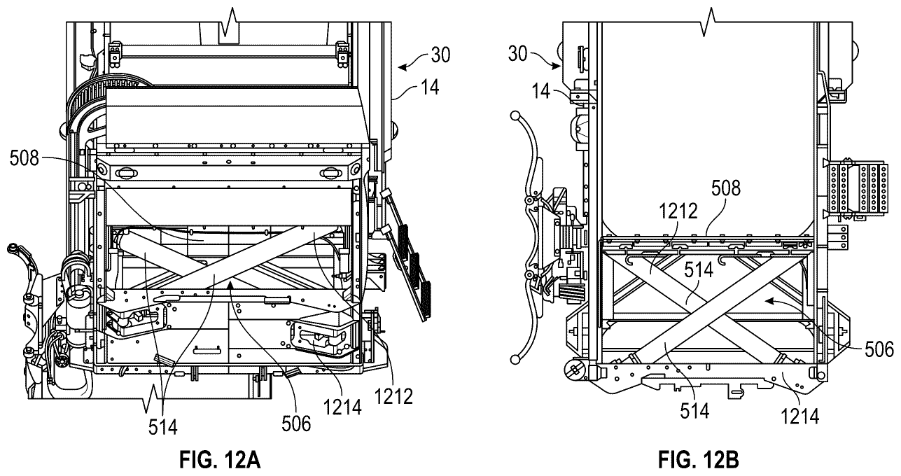

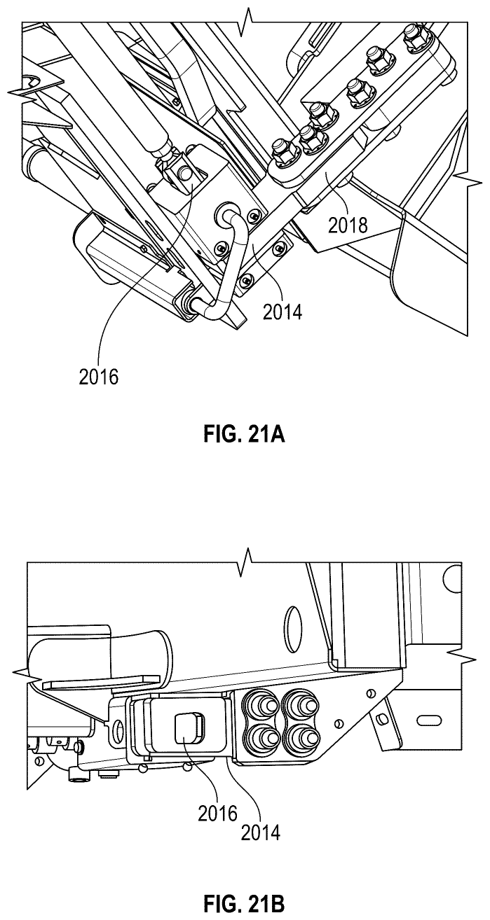

Referring now to FIGS. 12A-25, the refuse vehicle 10 may include a pack sensor to determine (e.g., measure) a quantity (e.g., a volume) of refuse stored within the storage volume 39 of the refuse compartment 30. The pack sensor may be used to determine the volume of packed, compacted, and/or stored refuse within the storage volume 39, rather than a loose accumulation of refuse within the hopper volume of the refuse compartment 30. Accordingly, the pack sensor may be used to detect a packout condition of the refuse vehicle 10 (e.g., a condition in which the storage volume 39 of the refuse compartment 30 is full and refuse within the storage volume 39 must be ejected before additional refuse may be collected by the refuse vehicle 10).

### Packing Assembly Sensor

As shown in FIGS. 12A-15C, the pack sensor may be configured to generate sensor data indicative of (e.g., to measure) a position or orientation of a component part of a packing assembly 506 during a packing procedure and to output data indicative of the position or orientation. The sensor data output by the pack sensor may be used to determine the quantity (e.g., volume) of refuse within the storage volume 39 of the refuse compartment 30.

Referring now specifically to FIGS. 12A and 12B, a packing assembly 506 is shown, according to an exemplary embodiment. The packing assembly 506 includes a pack panel 508 and a pair of packing actuators 514. As shown in FIGS. 12A and 12B, the pair of packing actuators 514 are linear actuators (e.g., hydraulic cylinders, electric linear actuators, etc.). As described in reference to FIGS. 4-11, the pack panel 508 is configured to move within the refuse compartment 30 of the refuse vehicle 10, between a retracted position (see, e.g. FIGS. 4, 6, and 9) and an extended position (see, e.g., FIGS. 8 and 11). The pair of packing actuators 514 are selectively extended or retracted to move the pack panel 508 between the extended position and the retracted position. Each packing actuator of the pair of packing actuators 514 is pivotally coupled at a first end 1212 to the pack panel 508. Each packing actuator of the pair of packing actuators 514 may further be pivotally coupled at a second end 1214 to an interior wall of the refuse compartment 30 of the refuse vehicle 10. As each packing actuator of the pair of packing actuators 514 extends, the first end 1212 pivots about an axis defined by the pivotal coupling of the first end 1212 to the pack panel 508, and the second end 1214 pivots about an axis defined by the pivotal coupling of the second end 1214 to the interior wall of the refuse compartment 30.

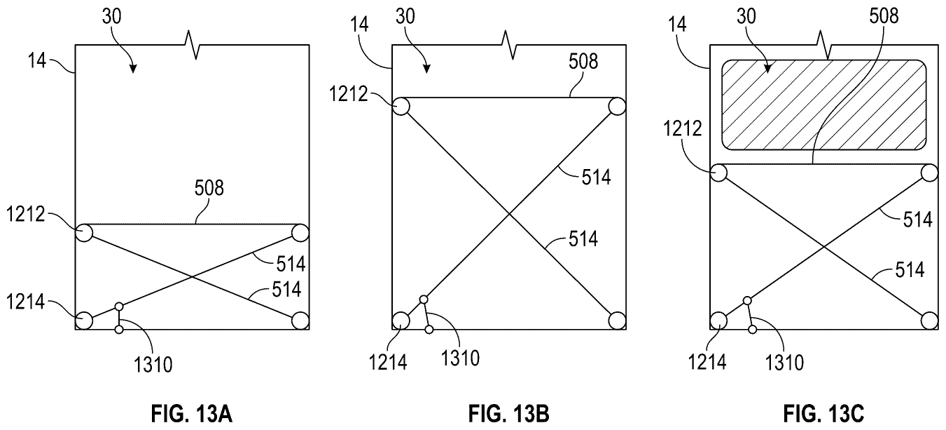

In some embodiments, the extension of the pack panel 508 is halted at an intermediate position between the retracted position and the extended position when the force required to extend the pack panel 508 further toward the extended position exceeds a threshold. The threshold may indicate that the storage volume 39 of the refuse compartment 30 (e.g., a portion of the storage volume 39 beyond the intermediate position of extension) is full of compacted refuse (see, e.g., FIGS. 13C, 14C, and 15C).

For example, where the pair of packing actuators 514 are hydraulic linear actuators, extension of the pack panel 508 may be halted at an intermediate position between the retracted position and the extended position when the pressure within the hydraulic actuators, or a part of the fluid circuit controlling the hydraulic actuators, exceeds a threshold pressure. In another example, where the pair of packing actuators 514 are electric linear actuators, extension of the pack panel 508 may be halted at an intermediate position between the retracted position and the extended position when current drawn by the electric linear actuators exceeds a threshold current. After being halted at the intermediate position of extension, the pack panel 508 is returned to the retracted position so that additional refuse may be received into the refuse compartment 30. The intermediate position of extension of the pack panel 508, therefore, approximates the volume of refuse in the refuse compartment 30 by dividing the storage volume 39 of the refuse compartment 30 into full and vacant volumes. In some embodiments, the pack sensor is configured to measure the position of the pack panel when the pack panel is at the intermediate position of extension.

Referring now to FIGS. 13A-13C, the pack sensor may be a linear encoder, shown as linear encoder 1310. The linear encoder 1310 has a first end and a second end. The first end of the linear encoder 1310 and the second end of the linear encoder 1310 are axially movable relative to one another, and the linear encoder 1310 is configured to output a data signal indicative of the position of the first end relative to the second end. One of the first end or the second end of the linear encoder 1310 may include a scale that encodes position information. The other of the first end or the second end of the linear encoder 1310 may include a transducer configured to read the scale and convert the position information encoded by the scale to a data signal to be output by the linear encoder 1310. The first end and the second end of the linear encoder 1310 may be telescopically coupled to one another such that one of the first end or the second end of the linear encoder 1310 is received within and extendable relative to the other of the first end or the second end of the linear encoder 1310.

In some embodiments, the first end of the linear encoder 1310 is coupled to a component part of the packing assembly 506 (e.g., one of the pair of packing actuators 514, the pack panel 508, etc.), and the second end of the linear encoder 1310 is coupled to the body 14 of the refuse vehicle 10. In an exemplary embodiment, the first end of the linear encoder is coupled to one of the pair of packing actuators 514, and the second end of the linear encoder 1310 is coupled to an inside surface of the body 14. The first end of the linear encoder 1310 may be coupled to the one of the pair of packing actuators 514 near the second end 1214 of the one of the pair of packing actuators 514. The second end of the linear encoder 1310 may be coupled to an inside surface of a panel 32 of the body 14 proximate and parallel to the cab 16 (i.e., a forward-facing wall of the body 14). The first end of the linear encoder 1310 may be pivotally coupled to the one of the pair of packing actuators 514, and the second end of the linear encoder 1310 may be pivotally coupled to the body 14.

As a packing process is performed, the pair of packing actuators 514 extend the pack panel 508 from a retracted position (see, e.g., FIG. 13A), to an extended position (see, e.g., FIG. 13B), and through partially extended positions (see, e.g., FIG. 13C) between the extended position and the retracted position. During the packing process, the second end 1214 of each packing actuator of the pair of packing actuators 514 pivots about the coupling of the second end 1214 to the body 14 of the refuse vehicle 10, causing the first end of the linear encoder 1310, coupled near the second end 1214 of one packing actuator of the pair of packing actuators 514, to move relative to the second end of the linear encoder 1310, coupled to the body 14 of the refuse vehicle 10. Because the data signal output by the linear encoder 1310 indicates the position of the first end of the linear encoder 1310 relative to the second end of the linear encoder 1310, the data signal output by the linear encoder 1310 during the packing process can be used to approximate the position of the pair of packing actuators 514, and, therefore, the position of the pack panel 508, relative to the body 14, throughout the packing process. When extension of the pack panel 508 is halted at an intermediate position between the retracted position and the extended position, because a threshold condition has been met indicating the refuse compartment beyond the intermediate position of extension is full (see, e.g., FIG. 13C), the data signal output by the linear encoder 1310 may be used to approximate the volume of refuse currently within the refuse compartment 30 of the refuse vehicle 10.

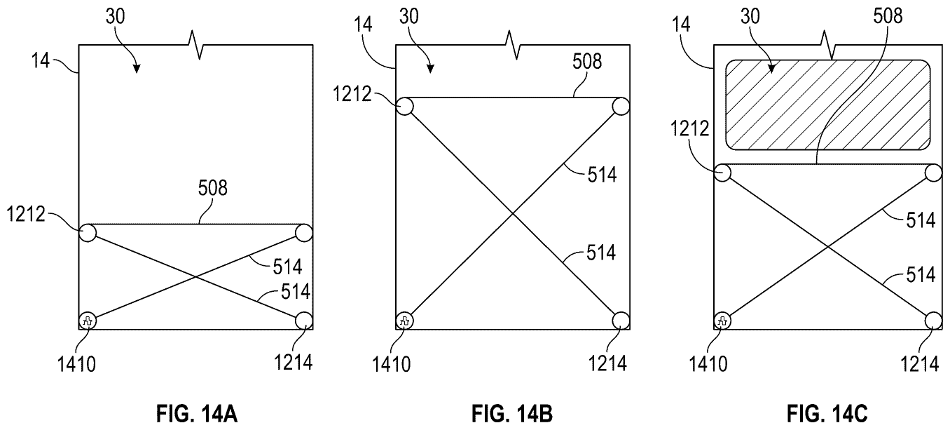

Referring now to FIGS. 14A-14C, the pack sensor may be a rotary encoder, shown as rotary encoder 1410. The rotary encoder 1410 has a stationary portion and a rotatable portion rotatably coupled to the stationary portion, and the rotary encoder 1410 is configured to output a data signal indicative of the angular position of the rotatable portion relative to the stationary portion. One of the rotatable portion or the stationary portion of the rotary encoder 1410 may include a code disk that encodes angular position information. The other of the rotatable portion or the stationary portion of the rotary encoder 1410 may include a transducer configured to read the code disk and convert the angular position information encoded by the code disk to an output signal. The rotatable portion of the rotary encoder 1410 may include a shaft, or a shaft coupling. The stationary portion of the rotary encoder 1410 may include a mounting flange, or bracket.

In some embodiments, the rotatable portion of the rotary encoder 1410 is coupled to one of the packing actuators of the pair of packing actuators 514, and the stationary portion of the rotary encoder 1410 is coupled to the body 14 of the refuse vehicle. In an exemplary embodiment, the rotatable portion of the rotary encoder 1410 is coupled to the second end 1214 of one of the pair of packing actuators 514, proximate the coupling of the second end 1214 to the body 14 of the refuse vehicle 10, and the stationary portion of the rotary encoder is coupled to an inside surface of the body 14, proximate the coupling of the second end 1214 of the one of the pair of packing actuators to the body 14 of the refuse vehicle 10. The rotary encoder 1410 may be integrated into the pivotal coupling of the second end 1214 of one of the pair of packing actuators 514 to the body 14 of the refuse vehicle such that the rotatable portion of the rotary encoder 1410 pivots relative to the stationary portion of the rotary encoder as the second end 1214 of the one of the pair of packing actuators 514 pivots relative to the body 14 of the refuse vehicle.

As a packing process is performed, the pair of packing actuators 514 extend the pack panel 508 from a retracted position (see, e.g., FIG. 14A), to an extended position (see, e.g., FIG. 14B), and through partially extended positions (see, e.g., FIG. 14C) between the extended position and the retracted position. During the packing process, the second end 1214 of each packing actuator of the pair of packing actuators 514 pivots about the coupling of the second end 1214 to the body 14 of the refuse vehicle 10, causing the rotatable portion of the rotary encoder 1410, coupled near the second end 1214 of one packing actuator of the pair of packing actuators 514, to rotate relative to the stationary portion of the rotary encoder 1410, coupled to the body 14 of the refuse vehicle 10. Because the data signal output by the rotary encoder 1410 indicates the angular position of the rotatable portion of the rotary encoder 1410 relative to the stationary portion of the rotary encoder 1410, the data signal output by the rotary encoder 1410 during the packing process can be used to approximate the position of the pair of packing actuators 514, and, therefore, the position of the pack panel 508, relative to the body 14, throughout the packing process. When extension of the pack panel 508 is halted at an intermediate position between the retracted position and the extended position, because a threshold condition has been met indicating the refuse compartment beyond the intermediate position of extension is full (see, e.g., FIG. 14C), the data signal output by the rotary encoder 1410 may be used to approximate the volume of refuse currently within the refuse compartment 30 of the refuse vehicle 10.

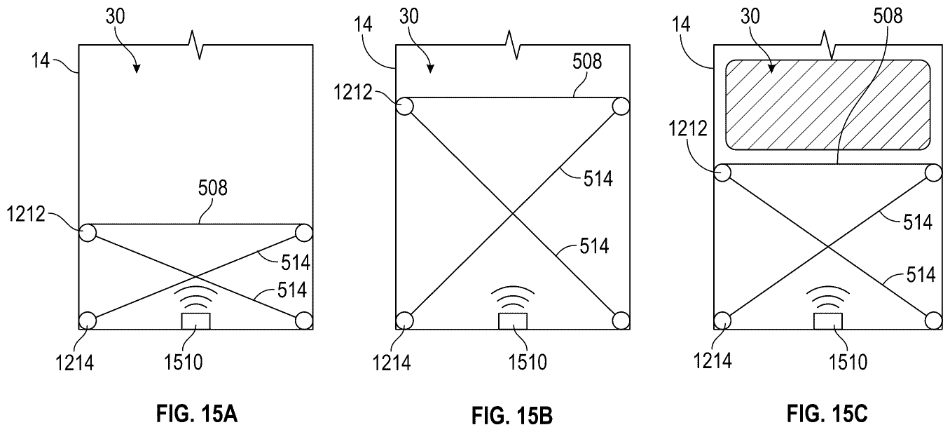

Referring now to FIGS. 15A-15C, the pack sensor may be a distance sensor, shown as distance sensor 1510. The distance sensor 1510 emits a signal towards a target and measures the characteristics of the signal that is reflected by the target to determine a distance between the distance sensor 1510 and the target. The distance sensor 1510 is configured to output a signal indicative of the distance between the distance sensor 1510 and the target on which it is trained. The distance sensor 1510 may be an ultrasonic distance sensor. The distance sensor 1510 may be an infrared distance sensor. The distance sensor 1510 may be a laser distance sensor (e.g., a LIDAR). In an exemplary embodiment, the distance sensor 1510 is positioned within the refuse compartment 30 of the refuse vehicle 10 and trained on the pack panel 508 so that the signal output by the distance sensor 1510 indicates the distance between the pack panel 508 and the distance sensor 1510. In some embodiments, the distance sensor is positioned within the refuse compartment 30 at a location behind the pack panel 508 (i.e. at a position between the pack panel 508 and the cab 16 of the refuse vehicle 10). In some embodiments, the distance sensor is coupled to an inside surface of a panel 32 of the body 14 of the refuse vehicle 10.

As a packing process is performed, the pair of packing actuators 514 extend the pack panel 508 from a retracted position (see, e.g., FIG. 15A), to an extended position (see, e.g., FIG. 15B), and through partially extended positions (see, e.g., FIG. 15C) between the extended position and the retracted position. Because the data signal output by the distance sensor 1510 indicates the distance between the pack panel 508 and the distance sensor 1510, the data signal output by the distance sensor 1510 during the packing process can be used to approximate the position of the pack panel 508, relative to the body 14, throughout the packing process. When extension of the pack panel 508 is halted at an intermediate position between the retracted position and the extended position, because a threshold condition has been met indicating the refuse compartment beyond the intermediate position of extension is full (see, e.g., FIG. 15C), the data signal output by the distance sensor 1510 may be used to approximate the volume of refuse currently within the refuse compartment 30 of the refuse vehicle 10.

### Strain Gauge

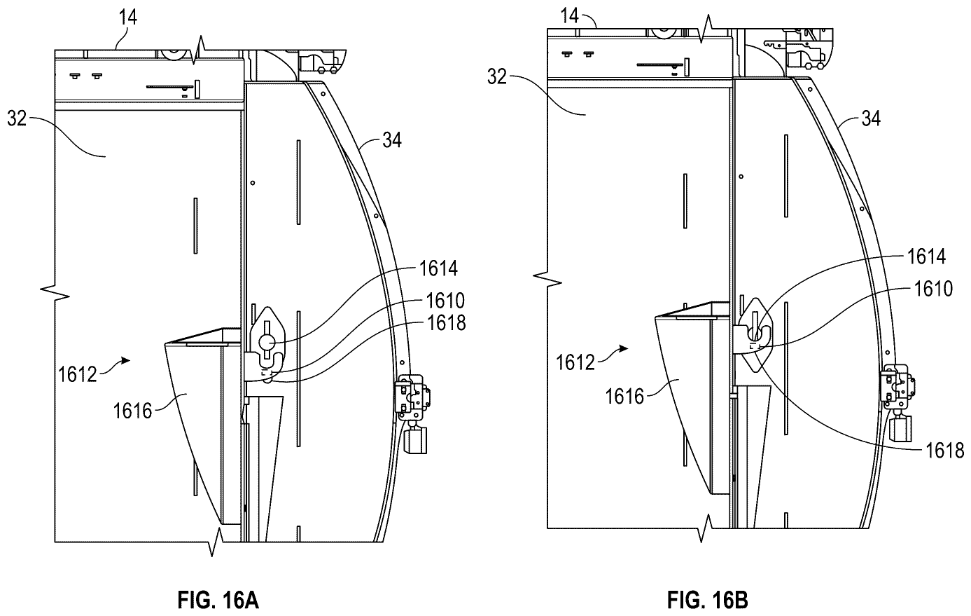

Referring now to FIGS. 16A-23B, the pack sensor may be a strain gauge, shown as strain gauge 1610. The strain gauge 1610 is a device configured to measure the strain, or deformation, of an object to which the strain gauge 1610 is fixed, and to output a signal indicative of the strain. The strain gauge 1610 may be fixed to a component of the refuse vehicle 10 subject to strain or deformation during a packing process. The output of the strain gauge 1610 may be monitored over the duration of a packing process, and over successive packing processes, to determine the volume of refuse within the refuse compartment 30 of the refuse vehicle 10.

As described in reference to FIG. 1, the tailgate 34 may be hingedly or pivotally coupled with the body 14 at a rear end of the body 14 and rotatable between an open position and a closed position. When the tailgate 34 is in the opened position, refuse within the refuse compartment 30 may be ejected from the refuse compartment 30 by the packing assembly 506. When the tailgate 34 is in the closed position, the tailgate 34 provides a surface against which refuse within the refuse compartment 30 may be compacted by the packing assembly 506. In some embodiments, the refuse vehicle 10 further includes a locking mechanism to selectively secure the tailgate 34 in the closed position. The strain gauge may be fixed to a component of the locking mechanism to measure the strain placed on the component of the locking mechanism by a packing process.

In an exemplary embodiment, and as shown in FIGS. 16A and 16B, the locking mechanism is a sliding lock assembly, shown as mid-body sliding lock assembly 1612. The mid-body sliding lock assembly 1612 includes a stud 1614 and a sliding latch body 1616. The stud 1614 is fixed, or integral, to the tailgate 34 and is positioned at a location between the top and bottom of the tailgate 34. The stud 1614 may be a rod or pin projecting from an outer surface of the tailgate 34. As shown in FIGS. 16A and 16B, the stud 1614 may be substantially cylindrical. In other embodiments, the stud 1614 may be otherwise shaped (e.g., square, polygonal, or irregularly shaped). The sliding latch body 1616 is slidably coupled to one of the panels 32 of the body 14 and is movable along the vertical axis (i.e., an axis perpendicular to the ground on which the refuse vehicle 10 travels) and movable between an unlocked position (see, e.g., FIG. 16A) and a locked position (see, e.g., FIG. 16B). The sliding latch body 1616 has a notched latching member 1618 which extends beyond a rear edge of the body 14. The notched latching member has a notch, or recess, configured to receive the stud 1614 when the sliding latch body 1616 is moved to the locked position (see, e.g., FIG. 16B) and to release the stud 1614 when the sliding latch body 1616 is moved to the unlocked position (see, e.g., FIG. 16A), thus selectively securing the tailgate 34 in the closed position. The strain gauge 1610 may be fixed to the notched latching member 1618 of the sliding latch body 1616 to measure the strain, or deformation, of the notched latching member 1618 during a packing process.

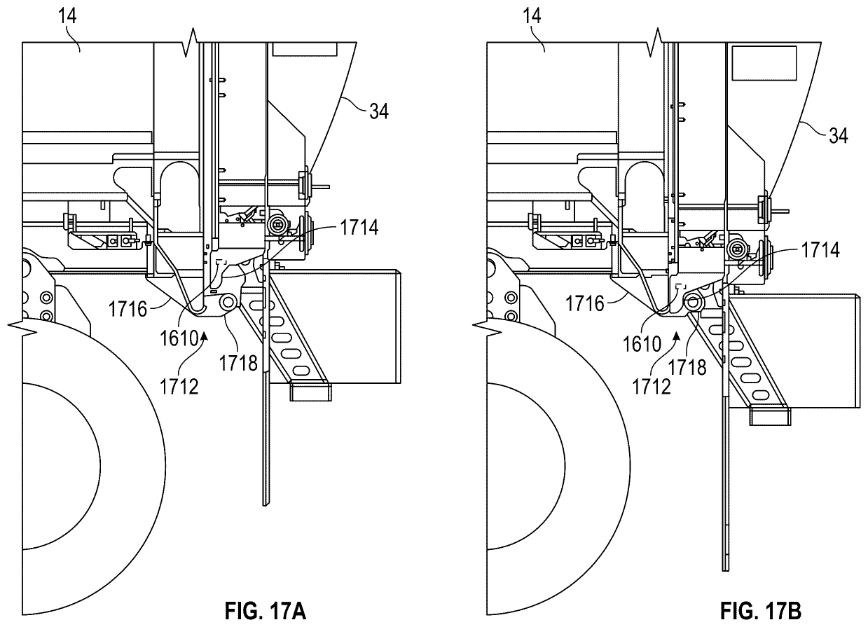

In an exemplary embodiment, and as shown in FIGS. 17A and 17B, the locking mechanism is a sliding lock assembly, shown as lower body sliding lock assembly 1712. The lower body sliding lock assembly 1712 includes a latched member 1714 and a sliding latch body 1716. The latched member 1714 is fixed, or integral, to the tailgate 34 and extends below a bottom edge of the tailgate 34. As shown in FIGS. 17A and 17B, the latched member 1714 is irregularly shaped. In other embodiments, the latched member 1714 may be otherwise shaped (e.g., cylindrical, square, polygonal, etc.). The sliding latch body 1716 is slidably coupled to the body 14 and is movable along the vertical axis (i.e., an axis perpendicular to the ground on which the refuse vehicle 10 travels) between an unlocked position (see, e.g., FIG. 17A) and a locked position (see, e.g., FIG. 17B). The sliding latch body 1716 has a latching member 1718 which extends beyond a rear edge of the body 14. The latching member 1718 has a notch, or recess, configured to receive the latched member 1714 when the sliding latch body 1716 is moved to the locked position (see, e.g., FIG. 17B) and to release the latched member 1714 when the sliding latch body 1716 is moved to the unlocked position (see, e.g., FIG. 17A), thus selectively securing the tailgate 34 in the closed position. The strain gauge 1610 may be fixed to the latched member 1714 to measure the strain, or deformation, of the latched member 1714 during a packing process.

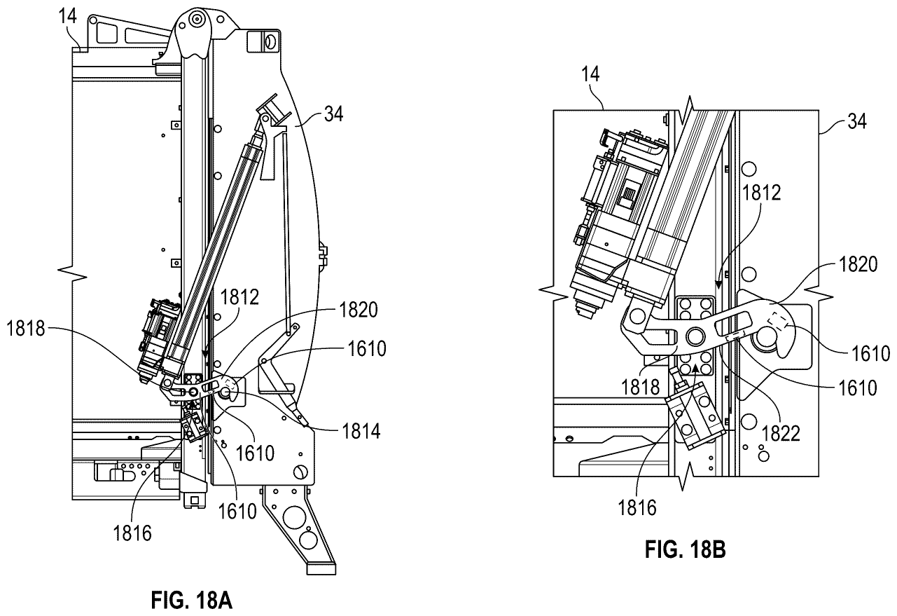

In an exemplary embodiment, and as shown in FIGS. 18A and 18B, the locking mechanism is a pivot lock assembly, shown as pivot lock assembly 1812. The pivot lock assembly includes a stud 1814 and a latch 1816. The stud 1814 is fixed, or integral, to the tailgate 34 and is positioned at a location between the top and bottom of the tailgate 34. The stud 1814 may be a rod or pin projecting from an outer surface of the tailgate 34. As shown in FIGS. 18A and 18B, the stud 1814 may be substantially cylindrical. In other embodiments, the stud 1814 may be otherwise shaped (e.g., square, polygonal, or irregularly shaped). The latch 1816 is a single component made from a single piece of material (e.g., steel, etc.). The latch 1816 has a pivot portion 1818, a latching portion 1820, and a shank 1822 connecting the pivot portion 1818 and the latching portion 1820. The pivot portion 1818 is pivotally coupled to the body 14 and is rotatable between a locked position and an unlocked position. The latching portion 1820 has a notch, or recess, configured to receive the stud 1814 when the pivot portion 1818 is rotated to the locked position, and to release the stud 1814 when the pivot portion 1818 is rotated to the unlocked position, thus selectively securing the tailgate 34 in the closed position. The strain gauge 1610 may be fixed to the latching portion 1820 of the latch 1816 to measure the strain, or deformation, of the latching portion 1820 of the latch 1816 during a packing process. The strain gauge 1610 may be fixed to the shank 1822 of the latch 1816 to measure the strain, or deformation, of the shank 1822 of the latch 1816 during a packing process.

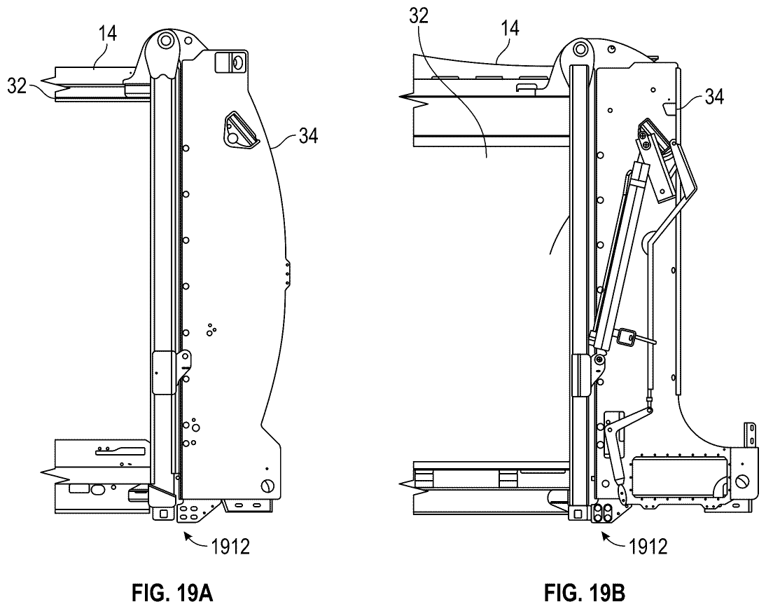

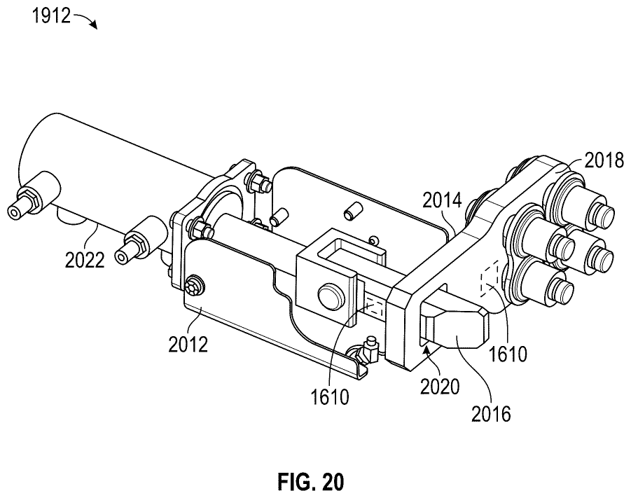

In an exemplary embodiment, and as shown in FIGS. 19A-22, the locking mechanism is a pin lock assembly, shown as pin lock assembly 1912. As shown in FIG. 20, the pin lock assembly 1912 includes a pin assembly 2012 and a locking plate 2014. The pin assembly 2012 is coupled to the body 14 of the refuse vehicle 10 and includes a locking pin 2016. The locking pin 2016 is movable between an unlocked position and a locked position. The locking pin 2016 may be actuated between the unlocked position and the locked position by a linear actuator 2022 (e.g., a hydraulic actuator, a pneumatic actuator, an electric solenoid, etc.). The locking plate 2014 has a mounting end 2018 which defines one or more aperture through which fasteners (e.g., bolts, screws, clips, etc.) may be inserted to fasten the locking plate 2014 to the tailgate 34 of the refuse vehicle 10. The locking plate has a second end which defines a pin aperture 2020 configured to receive the locking pin 2016 when the locking pin 2016 is extended to the locked position. As shown in FIG. 20, in some embodiments, the strain gauge 1610 may be fixed to a part of the locking plate 2014 between the mounting apertures and the pin aperture 2020 to measure the strain, or deformation of the locking plate 2014 during a packing process. In some embodiments, the strain gauge 1610 may be fixed to the locking pin 2016 to measure the strain, or deformation of the locking pin 2016 during a packing process.

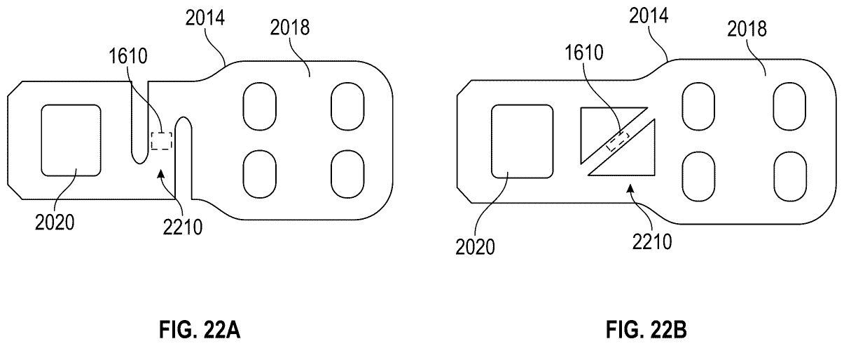

In some embodiments, where the strain gauge 1610 is fixed to the locking plate 2014, the locking plate 2014 may have a geometry that increases the degree to which the locking plate 2014 is deformed when under strain from the packing assembly 506 during a packing process. For example, and as shown in FIGS. 22A and 22B, the locking plate may be cut or milled in the area between the mounting end 2018 and the pin aperture 2020.

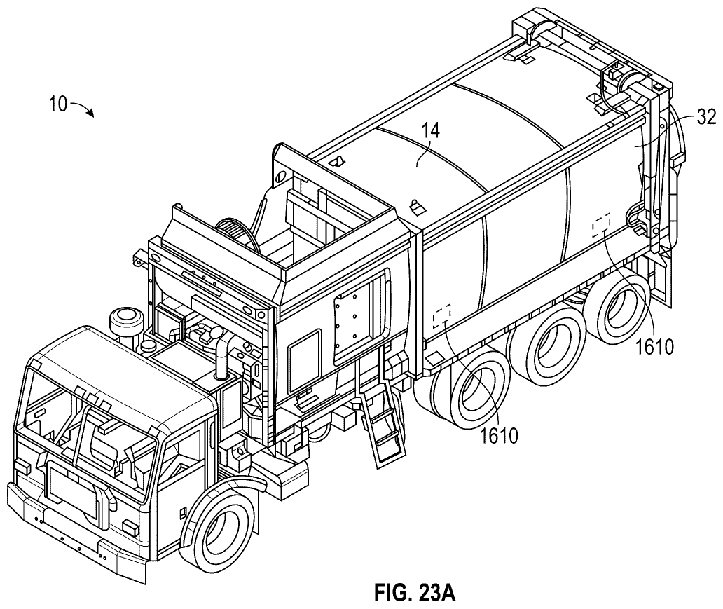

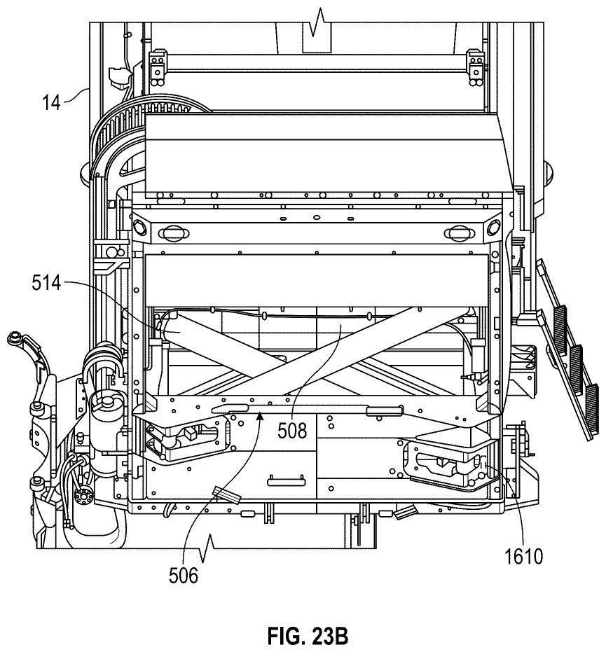

The strain gauge 1610 may be positioned in other locations in various exemplary embodiments, such as the locking plate, the lock pin, a lower latch, a mid latch, a pivot latch, a body in a region adjacent an end of the pack stroke of the packing panel, etc. In an exemplary embodiment, and as shown in FIGS. 23A and 23B, the strain gauge 1610 may be fixed to the body 14 of the refuse vehicle 10. The strain gauge 1610 may be fixed to the body 14 in an area proximate the coupling of the packing actuator 514 and the body 14 (e.g., in or on a headframe of the body) to measure the strain or deformation of the body 14 during a packing process. In some embodiments, the strain gauge 1610 is fixed to a side wall of the body 14 (i.e. one of the panels 32 defining the body 14). The strain gauge 1610 may be fixed to an area of the body 14 along which the pack panel 508 travels during a packing process. For example, the strain gauge 1610 may be fixed to a part of the body 14 proximate the position of the pack panel 508 when the pack panel 508 is in the extended position. Alternatively, the strain gauge 1610 may be fixed to a part of the body 14 proximate the position of the pack panel 508 when the pack panel 508 is in the retracted position.

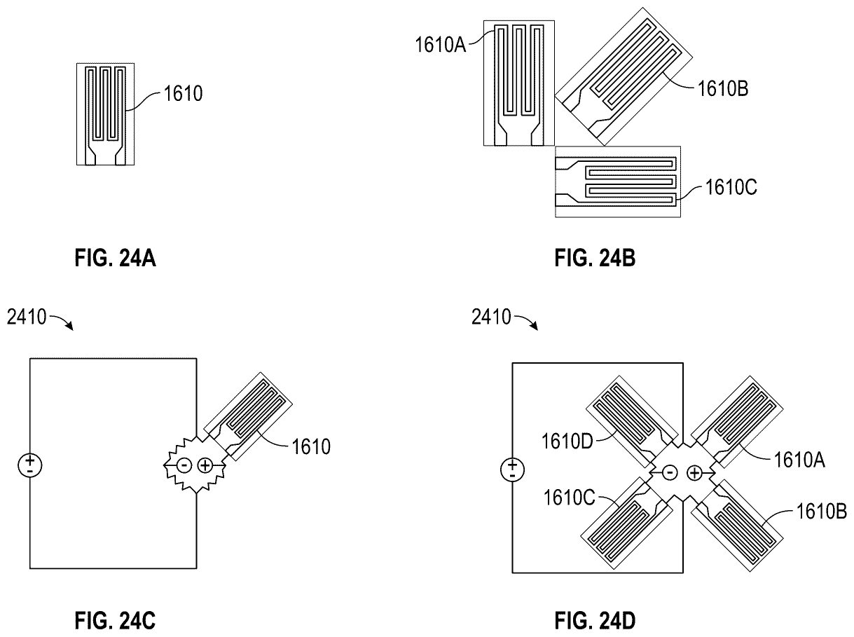

Referring now to FIGS. 24A-24D, the strain gauge 1610 may be a single strain gauge (see, e.g., FIG. 24A) or it may be one of a plurality of closely positioned strain gauges, each oriented to measure strain along different directions (see, e.g., FIG. 24B). In an exemplary embodiment, and as shown in FIG. 24B, the strain gauge is one of three strain gauges, 1610A, 1610B, and 1610C, arranged in a rosette pattern. Each of the three strain gauges is fixed to the same surface (e.g., the body 15 of the refuse vehicle 10, a component of a tailgate locking mechanism, etc.). A second (e.g., 1610B) of the three strain gauges is oriented at a 45-degree angle relative to a first (e.g., 1610A) of the three strain gauges, and a third (e.g., 1610C) of the three strain gauges is oriented at a 90-degree angle relative to the first (e.g., 1610A) of the three strain gauges.

In some embodiments, and as shown in FIGS. 24C and 24D, the amount of strain placed on the strain gauge 1610 may be measured by a Wheatstone bridge circuit 2410. Where only one strain gauge is employed, the Wheatstone bridge circuit 2410 may be a quarter Wheatstone bridge circuit (see, e.g., FIG. 24C). Where multiple strain gauges are employed, the Wheatstone bridge circuit 2410 may be a half Wheatstone bridge circuit or a full Wheatstone bridge circuit (see, e.g., FIG. 24D). The Wheatstone bridge circuit 2410 may be integrated into a controller that is configured to receive data from the strain gauge 1610. The Wheatstone bridge circuit may be a part of an intermediate component (e.g., a signal conditioner, transmitter, etc.) external and connected to a controller.

### Hydraulic Sensors

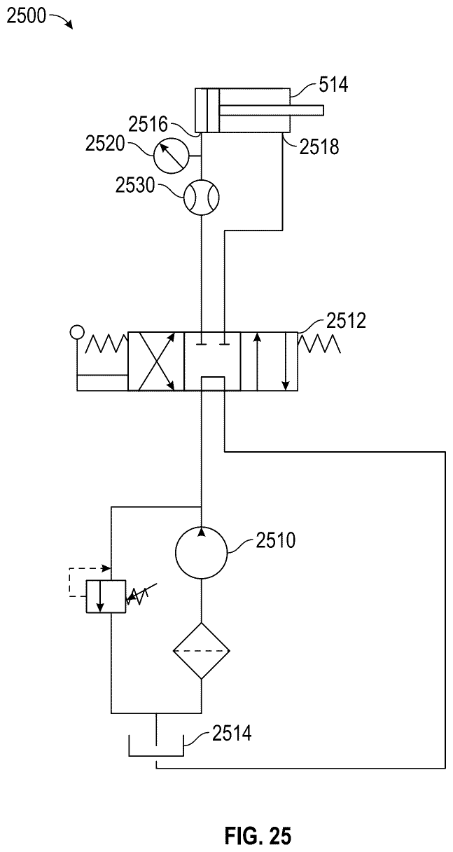

Referring now to FIG. 25, in some embodiments, where the packing actuator 514 is a hydraulic linear actuator, the pack sensor may be a sensor configured to measure an operating characteristic of the fluid circuit controlling the packing actuator 514. In an exemplary embodiment, a fluid circuit 2500 for controlling a packing actuator 514 includes a hydraulic pump 2510 and a directional control valve 2512. The hydraulic pump 2510 draws hydraulic fluid into the fluid circuit 2500 from a reservoir 2514 and pressurizes the hydraulic fluid. The directional control valve 2512 selectively directs the flow of the pressurized hydraulic fluid into either a cap end port 2516 of the packing actuator 514, to cause the packing actuator 514 to extend, or into a rod end port 2518 of the packing actuator 514, to cause the packing actuator 514 to retract. The directional control valve 2512 may be electronically controlled (e.g., by a controller) or the directional control valve 2512 may be manually controlled (e.g., by an operator of the refuse vehicle 10).

In an exemplary embodiment, the pack sensor is a pressure sensor, shown as pressure sensor 2520. The pressure sensor 2520 measures the pressure exerted on the pressure sensor 2520 by a fluid and outputs a data signal indicative of the same. In some embodiments, the pressure sensor 2520 may be a piezoelectric pressure sensor. In some embodiments, the pressure sensor 2520 may be a strain gauge pressure sensor. In some embodiments, the pressure sensor 2520 may be a capacitive pressure sensor. In some embodiments, the pressure sensor 2520 is fluidly coupled to the cap end port 2516 of the packing actuator 514 so that the pressure sensor 2520 measures the pressure of the hydraulic fluid entering the cap end port 2516 of the packing actuator 514. In some embodiments, the pressure sensor 2520 measures a pressure of hydraulic fluid supplied to the packing actuator 514. In some embodiments, the pressure sensor 2520 measures a pressure of hydraulic fluid supplied to the cap end port 2516 of the packing actuator 514. In some embodiments, the pressure sensor 2520 is fluidly coupled to a branch of the fluid circuit 2500 between the directional control valve 2512 and the cap end port 2516 of the packing actuator 514. In other embodiments, the pressure sensor 2520 is fluidly coupled directly to the packing actuator 514.

As a packing process is performed, hydraulic fluid is directed into the cap end port 2516 of the packing actuator 514, by the directional control valve 2512, to extend the packing actuator and, therefore, the pack panel 508, from a retracted position to an extended position, and through partially extended positions between the retracted and extended positions. Because the data signal output by the pressure sensor 2520 indicates the pressure of the hydraulic fluid in the packing actuator 514, the data signal output by the pressure sensor 2520 during the packing process can be used to approximate the position of the pack panel 508 within the refuse compartment 30 of the refuse vehicle 10. For example, when extension of the pack panel 508 is halted at an intermediate position between the retracted position and the extended position, because a threshold condition has been met indicating the refuse compartment beyond the intermediate position of extension is full, the data signal output by the pressure sensor 2520, when viewed over the duration of the packing process, and between successive packing processes, may be used to approximate the volume of refuse currently within the refuse compartment 30 of the refuse vehicle 10.

In an exemplary embodiment, the pack sensor is a flow meter, shown as flow meter 2530. The flow meter 2530 measures a flow rate of a fluid through the flow meter 2530 and outputs a data signal indicative of the same. In some embodiments, the flow meter 2530 may be a turbine flow meter. In some embodiments, the flow meter 2530 may be a magnetic flow meter. In some embodiments, the flow meter 2530 may be a positive displacement flow meter. In some embodiments, the flow meter 2530 may be a gear flow meter. The flow meter 2530 is fluidly coupled to the fluid circuit 2500 between the directional control valve 2512 and the cap end port 2516 of the packing actuator 514 so that hydraulic fluid directed by the directional control valve 2512 to the cap end port 2516 of the packing actuator 514 flows through the flow meter 2530. In some embodiments, the flow meter 2530 is configured to measure a flow of hydraulic fluid supplied to the packing actuator 514. In some embodiments, the flow meter 2530 measures a flow of hydraulic fluid into the packing actuator 514.

As a packing process is performed, hydraulic fluid is directed into the cap end port 2516 of the packing actuator 514, by the directional control valve 2512, to extend the packing actuator and, therefore, the pack panel 508, from a retracted position to an extended position, and through partially extended positions between the retracted and extended positions. Because the data signal output by the flow meter 2530 indicates the rate of flow to the packing actuator, the data signal output by the flow meter 2530 during the packing process can be used to approximate the position of the pack panel 508 within the refuse compartment 30 of the refuse vehicle 10. For example, the flow rate of hydraulic fluid into the packing actuator 514 may be used to approximate the volume of hydraulic fluid that is directed into the cap end port 2516 of the packing actuator 514, and, therefore, the degree to which the packing actuator 514 is extended from the retracted position. When extension of the pack panel 508 is halted at an intermediate position between the retracted position and the extended position, because a threshold condition has been met indicating the refuse compartment beyond the intermediate position of extension is full, the data signal output by the flow meter 2530 may be used to approximate the volume of refuse currently within the refuse compartment 30 of the refuse vehicle 10.

### Integrated Sensors

In some embodiments, the pack sensor may be integrated with a component of the packing assembly 506. For example, the pack sensor may be integrated with the packing actuator 514, a motor configured to drive the packing actuator 514, or another actuator component of the packing assembly 506. In some embodiments, the pack sensor includes an encoder, position sensor, rotation sensor, or other sensor integrated with the packing actuator 514 and/or the motor. The integrated pack sensor may be configured to detect a position, displacement, rotation, extension, retraction, or other movement-related operating characteristic of the packing assembly 506. In some embodiments, the integrated pack sensor may be incorporated into actuator controls or motor controls such that operating data associated with the packing actuator 514 or the motor may be used to determine movement of the packing assembly 506. In some embodiments, data from the integrated pack sensor may be used to determine the position of the pack panel 508 within the refuse compartment 30, determine the degree to which the packing actuator 514 is extended or retracted, determine a packed, compacted, and/or stored volume of refuse within the storage volume 39, and/or detect a packout condition of the refuse vehicle 10.

### Controller

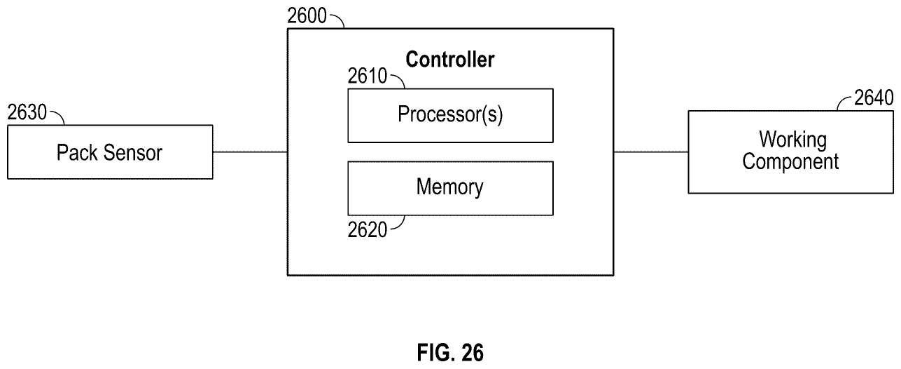

In some embodiments, and as shown in FIG. 26, the refuse vehicle 10 includes a controller, shown as pack volume detection controller 2600. The pack volume detection controller 2600 includes one or more processors 2610 operatively connected and configured to execute instructions stored on a memory 2620. The one or more processors 2610 can be implemented as a general-purpose processor, an application specific integrated circuit (ASIC), one or more field programmable gate arrays (FPGAs), a group of processing components, or other suitable electronic processing components.

The memory 2620 (e.g., memory, memory unit, storage device, etc.) can include one or more devices (e.g., RAM, ROM, flash memory, hard disk storage, etc.) for storing data and/or computer code for completing or facilitating the various processes, layers and modules described in the present application. The memory 2620 can be or include volatile memory or non-volatile memory. The memory 2620 can include database components, object code components, script components, or any other type of information structure for supporting the various activities and information structures described in the present application. According to some embodiments, memory 2620 is communicably connected to the one or more processors 2610 and includes computer code for executing one or more processes described herein.

The pack volume detection controller 2600 is configured to receive data from a pack sensor 2630. The pack volume detection controller 2600 may determine the volume of refuse stored within the storage volume 39 or determine whether the volume of refuse stored within the storage volume 39 satisfies a threshold volume, based on the data received from the pack sensor 2630. In some embodiments, the pack volume detection controller 2600 is configured to initiate a remedial action in response to determining that the threshold volume has been satisfied. The pack sensor 2630 may be the linear encoder 1310, the rotary encoder 1410, the distance sensor 1510, the strain gauge 1610, the pressure sensor 2520, or the flow meter 2530, in various embodiments. In some embodiments, the pack volume detection controller 2600 is configured to operatively control a working component 2640 of the refuse vehicle 10. The working component 2640 may be the packing assembly 506 or the lift assembly 40 or 50, in various embodiments. In some embodiments the pack volume detection controller 2600 is implemented on, or constitutes a subcomponent of, a vehicle controller. In other embodiments, the pack volume detection controller 2600 is a standalone controller, dedicated to the operation of the pack sensor 2630.

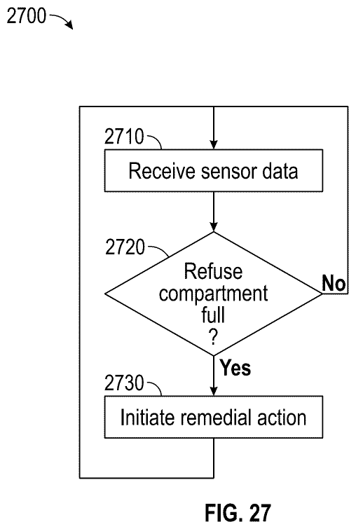

Referring to FIG. 27, a flow diagram of a method 2700 for measuring a volume of refuse within the refuse compartment 30 of a refuse vehicle 10 is provided, according to an exemplary embodiment. The method 2700 may be implemented on pack volume detection controller 2600 and will therefore be described with reference to FIG. 26. In other embodiments, the method 2700 may include additional, fewer, and/or different operations.

The method 2700 includes receiving pack sensor data, at operation 2710. In some embodiments, operation 2710 includes receiving, by the controller from the pack sensor, sensor data indicative of the volume of refuse within the refuse compartment 30 of the refuse vehicle 10. The pack sensor data may be in the form of digital or analog electrical signals. Operation 2710 may include storing the pack sensor data in memory (e.g., memory 2620) for subsequent processing, and/or transmission to a cloud or other remote computing device (e.g., a fleet management service, etc.).

The method 2700 includes determining whether the volume of refuse within the refuse compartment 30 of the refuse vehicle 10 satisfies a threshold volume, at operation 2720. For example, operation 2720 may include determining whether the volume of refuse within the refuse compartment 30 is at or near the capacity of the refuse compartment 30. As used in this context, satisfying the threshold volume may include equaling the threshold volume, exceeding the threshold volume, exceeding the threshold volume by at least a predetermined amount, and/or being within a predetermined range of the threshold volume.

Operation 2720 includes determining, by the controller and based on the data received at operation 2710, the volume of refuse in the refuse compartment 30. In an exemplary embodiment, where the pack sensor is a sensor configured to measure the position of the pack panel 508 during a packing process (e.g., linear encoder 1310, rotary encoder 1410, distance sensor 1510, etc.), the data output by the pack sensor, and received by the controller, may be analyzed by the controller to determine how far between the retracted position and the extended position the pack panel 508 travels before the packing process is halted because a threshold condition is met that indicates the refuse compartment 30 beyond the pack panel 508 is already full of compacted refuse. In another exemplary embodiment, where the pack sensor is a strain gauge (e.g., strain gauge 1610), the data output by the pack sensor, and received by the controller, may be analyzed by the controller over the duration of a packing process, and in relation to prior packing processes, to determine the degree to which the refuse compartment 30 is full. In another exemplary embodiment, where the pack sensor is a sensor configured to measure an operating characteristic of the fluid circuit controlling a hydraulic packing actuator (e.g., flow meter 2530, pressure sensor 2520, etc.), the data output by the pack sensor, and received by the controller, may be analyzed by the controller over the duration of a packing process, and in relation to prior packing processes, to determine the degree to which the refuse compartment 30 is full.

When it is determined at operation 2720 that the volume of refuse stored in the refuse compartment 30 satisfies the threshold volume (e.g., is at or near the capacity of the refuse compartment), method 2700 may include initiating remedial action, at operation 2730, in response to determining that the threshold volume has been satisfied. Operation 2730 may include disabling, by the controller, one or more working components of the refuse vehicle 10. For example, operation 2730 may disable a lift assembly (e.g., lift assembly 40, lift assembly 50, etc.), to prevent the introduction of more refuse into the refuse compartment 30. In some embodiments, operation 2730 may disable the packing assembly 506 to prevent damage to the packing assembly 506 or the body 14 of the refuse vehicle 10 that might result from overfilling the refuse compartment 30. In some embodiments, operation 2730 may present the operator of the refuse vehicle 10 with a warning or some indicator that the refuse compartment 30 is full so that the operator may undertake steps to empty the refuse compartment 30 before collecting additional refuse.

In some embodiments, operation 2730 may include directing the refuse vehicle 10 to a landfill, transfer station, or other refuse deposit location. For example, the controller 2600 may generate an instruction, notification, or output indicating that the refuse vehicle 10 should proceed to the refuse deposit location when the determined volume of refuse stored within the refuse compartment 30 satisfies the threshold volume. In some embodiments, the controller 2600 may output a warning to the operator indicating that the refuse vehicle 10 is full or nearly full and should be driven to the refuse deposit location. In some embodiments, the controller 2600 may communicate with a navigation system, vehicle controller, fleet management system, remote computing system, and/or route planning system to identify, recommend, select, and/or navigate to a refuse deposit location. The refuse deposit location may be selected based on one or more of a distance to the refuse deposit location, an estimated travel time to the refuse deposit location, traffic conditions, a type of refuse carried by the refuse vehicle 10, hours of operation of the refuse deposit location, and/or availability or capacity of the refuse deposit location.

In some embodiments, operation 2730 may include modifying a planned route of the refuse vehicle 10 based on the determined volume of refuse stored within the refuse compartment 30 so as to reduce a likelihood of overfilling the refuse compartment 30 before the refuse vehicle 10 reaches the refuse deposit location. For example, the controller 2600 may cause the refuse vehicle 10 to bypass one or more planned collection stops, skip one or more planned collection stops, reorder one or more planned collection stops, shorten a remaining portion of a collection route, and/or direct the refuse vehicle 10 to the refuse deposit location before completion of the originally planned collection route. In some embodiments, the controller 2600 may modify the planned route when the determined volume of refuse stored within the refuse compartment 30 is below full capacity but is sufficiently high that completion of the originally planned route would be likely to overfill the refuse compartment 30. For example, when the determined volume of refuse stored within the refuse compartment 30 satisfies a preliminary threshold volume that is below a full-capacity threshold volume, the controller 2600 may recommend or initiate a route change that reduces a number of remaining collection stops before unloading. In some embodiments, the controller 2600 may prioritize collection stops that are closer to the refuse deposit location, deprioritize collection stops associated with larger expected refuse volumes, and/or select a subset of remaining collection stops to be completed before the refuse vehicle 10 is directed to unload.

In some embodiments, operation 2730 may include presenting route-planning information to the operator through a display, user interface, map, turn-by-turn navigation output, audible output, and/or other operator notification. In some embodiments, operation 2730 may include automatically updating a planned route stored in a vehicle navigation system or transmitting updated route information to a fleet management system, dispatch system, remote computing system, and/or another vehicle. In some embodiments, the route modification may be based further on historical route data, expected refuse volumes for upcoming stops, operator inputs, geographic location of the refuse vehicle 10, and/or estimated remaining capacity of the refuse compartment 30.

It is noted that the various principles and pack sensor arrangements described herein can be combined with one another to improve accuracy of volume determination. For example, the pack pressure data can be used in combination with (e.g., compared to, averaged, etc.) sensor data regarding pack position, strain rate, pack panel position, and/or other sensor data to improve accuracy and to prevent false positives/negatives, such as could be caused by intermittent pressure spikes, jams, and the like. Sensor data can also be averaged over multiple cycles to improve measurement accuracy and/or to determine other hopper fill parameters, such as pack density. Such arrangements can also provide operational redundancy.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

References herein to a “remote computing system,” a “cloud,” or a “cloud computing system,” may include a computing system, or network of computing systems, having an edge computing device.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from the scope of the present disclosure or from the spirit of the appended claims.

What is claimed is:

1. A refuse vehicle comprising:
a chassis;
a cab coupled to the chassis;
a refuse compartment coupled to the chassis, the refuse compartment defining a storage volume;
a packing assembly disposed within the refuse compartment, the packing assembly including a pack panel and a packing actuator, wherein the packing actuator is configured to selectively move the pack panel between a retracted position and an extended position;
a pack sensor; and
a controller communicably coupled to the pack sensor, the controller configured to:
receive sensor data from the pack sensor;
determine, based on the sensor data, whether a volume of refuse stored within the storage volume satisfies a threshold volume; and
initiate a remedial action in response to determining that the volume of refuse satisfies the threshold volume.

2. The refuse vehicle of claim 1, wherein the pack sensor is a rotary encoder coupled to the packing actuator and configured to detect an angular position of the packing actuator relative to the refuse compartment.

3. The refuse vehicle of claim 1, wherein the pack sensor is a linear encoder coupled to the packing actuator and configured to detect linear displacement of the packing actuator relative to the refuse compartment.

4. The refuse vehicle of claim 1, wherein the pack sensor is a distance sensor mounted within the refuse compartment and configured to detect a position of the pack panel within the refuse compartment.

5. The refuse vehicle of claim 1, wherein the pack sensor is a strain gauge fixed to the refuse compartment and configured to detect strain of the refuse compartment.

6. The refuse vehicle of claim 1, further comprising:
a tailgate rotatably coupled to the refuse compartment and movable between an opened position and a closed position; and
a locking assembly configured to selectively secure the tailgate in the closed position;
wherein the pack sensor is a strain gauge fixed to a component of the locking assembly and configured to detect strain of the component of the locking assembly.

7. The refuse vehicle of claim 1, wherein the packing actuator is a hydraulic actuator, and wherein the pack sensor is a pressure sensor configured to measure a pressure of hydraulic fluid supplied to the packing actuator.

8. The refuse vehicle of claim 1, wherein the packing actuator is a hydraulic actuator, and wherein the pack sensor is a flow meter configured to measure a flow of hydraulic fluid into the packing actuator.

9. The refuse vehicle of claim 1, wherein the remedial action includes presenting a warning to an operator of the refuse vehicle, disabling the packing assembly, or disabling a lift assembly configured to load refuse into the refuse compartment.

10. A body for storing and compacting refuse, the body comprising:
a refuse compartment defining a storage volume;
a packing assembly disposed within the refuse compartment, the packing assembly including a pack panel and a packing actuator, wherein the packing actuator is configured to selectively move the pack panel between a retracted position and an extended position;
a pack sensor; and
a controller communicably coupled to the pack sensor, the controller configured to:
receive sensor data from the pack sensor; and
determine, based on the sensor data, a volume of refuse stored within the storage volume.

11. The body of claim 10, wherein the pack sensor is a rotary encoder coupled to the packing actuator and configured to detect an angular position of the packing actuator relative to the refuse compartment.

12. The body of claim 10, wherein the pack sensor is a linear encoder coupled to the packing actuator and configured to detect linear displacement of the packing actuator relative to the refuse compartment.

13. The body of claim 10, wherein the pack sensor is a distance sensor mounted within the refuse compartment and configured to detect a position of the pack panel within the refuse compartment.

14. The body of claim 10, wherein the pack sensor is a strain gauge fixed to the refuse compartment and configured to detect strain of the refuse compartment.

15. The body of claim 10, further comprising:
a tailgate rotatably coupled to the refuse compartment and movable between an opened position and a closed position; and
a locking assembly configured to selectively secure the tailgate in the closed position;
wherein the pack sensor is a strain gauge fixed to a component of the locking assembly and configured to detect strain of the component of the locking assembly.

16. The body of claim 10, wherein the packing actuator is a hydraulic actuator, and wherein the pack sensor is a pressure sensor configured to measure a pressure of hydraulic fluid supplied to the packing actuator or a flow meter configured to measure a flow of hydraulic fluid into the packing actuator.

17. A method of measuring a volume of refuse within a refuse compartment of a refuse vehicle, the method comprising:
receiving sensor data from a pack sensor;
determining, based on the sensor data, whether a volume of refuse stored within the refuse compartment satisfies a threshold volume; and
initiating a remedial action in response to determining that the volume of refuse satisfies the threshold volume.

18. The method of claim 17, wherein the remedial action includes presenting a warning to an operator of the refuse vehicle, disabling a packing assembly configured to compact refuse within the refuse compartment, or disabling a lift assembly configured to load refuse into the refuse compartment.

19. The method of claim 17, wherein the pack sensor is configured to detect a position of a packing actuator relative to the refuse compartment or a position of a pack panel relative to the refuse compartment.

20. The method of claim 17, wherein the pack sensor is a strain gauge configured to detect strain of the refuse compartment or a component of a locking assembly configured to selectively secure a tailgate of the refuse vehicle.
